(19) United States
(12) Patent Application Publication
(10) Pub. No.: US 2008/0231038 A1
(43) Pub. Date: Sep. 25, 2008

(54) CUSTOMIZED SCHOOL SPIRAL NOTEBOOK AND NOTEBOOK DESIGN AND PRODUCTION METHOD

(75) Inventors: Alejandro Canasi, San Francisco, CA (US); Mark Schelbert, Pacific Palisades, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: GPA Media, LLC, Berkeley, CA (US)

(21) Appl. No.: 11/688,176

(22) Filed: Mar. 19, 2007

(51) Int. Cl. B42D 1/00

(52) U.S. Cl. 281/27.1

(57) ABSTRACT

Customized school spiral notebooks are designed using school content information received from schools who are co-branding partners with the production coordinator and advertising content received from advertisers. The notebooks include front and back covers, a plurality of sheets including the school content information and at least some of the advertising content, and a plurality of divider sheets separating sets of writing paper, such as ruled, graph and/or blank paper. The divider sheets and/or the covers can also include at least some of the advertising content thereon. A plastic spiral binder holds the notebook together. The school content information can include a school phone directory, a campus map and an academic calendar; and a class planner can be provided on one of the content sheets. The respective customized notebooks are provided to each of the partner schools by the production coordinator at no charge, or a very minimal charge. Advertising profits can be shared with the partner schools.

### BACKGROUND OF THE INVENTION

The present invention is directed to spiral-bound notebooks and to methods and systems for designing and producing them.

An example of a spiral notebook sold to and used by students in colleges, universities and other schools is the FIVE STAR® notebook available from MeadWestvaco Corporation of Stamford, Conn. It is a five subject notebook having a flexible front cover and a stiff back cover, each with a storage pocket, and 200 sheets of NEAT SHEET® perforated college ruled paper between the covers. The pages can tear out to full 8½×11 inch sheets. The notebook is held together by a metal spiral binder. Printed on the front side of the back cover are an inch ruler, a centimeter ruler, conversion tables and formulae, a U.S. map with time zones and state capitals, computer key combinations and a space for writing phone numbers. A removable advertising/information longitudinal half-sheet is provided on top of the top cover and includes a product bar code. This notebook is rather expensive for students and is limited in the information and functions provided to the student.

Examples of notebooks known in the patent art are disclosed in the following U.S. Pat. Nos. 4,973,086 (Donnelly et al.), 5,997,207 (Robinson), 6,146,731 (Tanoto), 6,364,362 (Severin), 6,582,546 (Micek), 6,672,785 (O'Hara et al.), 6,739,785 (Moor), 6,773,195 (Tims), 6,837,641 (Paul), 6,932,534 (O'Hara) and 7,077,596 (Bianco et al.), and U.S. patent application Publication No. 2005/0105959 (Haynes). The entire contents of each of these patents and this publication are hereby incorporated by reference.

### SUMMARY OF THE INVENTION

Disclosed herein are customized school spiral notebooks which are designed by a production coordinator using school content information received from schools (who are partners with the production coordinator) and advertising content received from advertisers. The customized notebooks are provided to each of the respective partner schools by the production coordinator at no charge, or a very minimal charge. Advertising profits received from the coordinator can be shared with the partner schools pursuant to their co-branding partnership agreements.

These customized notebooks can include front and back covers, a plurality of sheets including the school content information and at least some of the advertising content, and a plurality of divider sheets, separating sets of writing paper. The divider sheets and/or the covers can also include at least some of the advertising content thereon. A plastic spiral binder can hold the notebook together. The school content information can include a school phone directory, a campus map and an academic calendar. And a class planner can be provided on one of the content sheets.

According to another aspect of the present invention the design of the school spiral notebook can include input from students of the school.

According to another aspect of the present invention the design of the school spiral notebook can include the school name, logo, mascot, seal or other identifying indicia on the front cover.

According to another aspect of the present invention this school spiral notebook can include the custom content including business directory information for businesses local to the school.

According to another aspect of the present invention this school spiral notebook can include the divider sheets being tabbed divider sheets, at least one of which includes the custom content specific to the school or the advertising content.

According to another aspect of the present invention this school spiral notebook can include the school content information including a directory of phone numbers for the school, a directory of phone numbers for businesses near the school, a map of the school campus, and a calendar of events associated with the school.

According to another aspect of the present invention this custom spiral notebook can include a class planner page defining locations for the student recipient to write the times, days and locations of his or her classes for that semester or quarter.

According to another aspect of the present invention the design of the school spiral notebook can include customized input from individual intended student recipients of each of the notebooks whereby the spiral notebooks are custom designed and produced for individual students (or for small groups of students) in a school.

According to another aspect of the present invention a school spiral notebook is provided which includes an attached RFID tag allowing a student recipient of the custom spiral notebook to track the location of his or her notebook and/or an attached RFID tag providing to at least one of the advertisers proof of receipt and use of the notebook by the students.

According to another aspect of the present invention a school spiral notebook is provided which includes a plastic sheet with pockets adapted to hold two optical discs such as CD-ROMs on each side of the sheet.

According to another aspect of the present invention a school spiral notebook is provided which includes a bar code allowing for verification of distribution of the spiral notebooks to students, and/or for tracking of advertisements or other promotions.

According to another aspect of the present invention a school spiral notebook is provided which includes a thin solar-powered calculator impregnated inside a page thereof.

According to another aspect of the present invention a school spiral notebook is provided which includes a horoscope for each month of a semester or quarter of the school and hidden by a scratchable covering

According to another aspect of the present invention a school spiral notebook is provided which includes a spiral binder and a sealable pouch positioned in the spiral binder for storage of one or more small articles belonging to the student recipient.

According to another aspect of the present invention a school spiral notebook is provided which includes a flexible whiteboard sheet on which erasable notes can be written with a dry erase pen by the student, the pen being attached with a cord to the notebook or removably stored in a notebook pocket.

According to another aspect of the present invention a school spiral notebook is provided which includes a notebook-specific code for the student to enter an online prize contest and/or a notebook-specific code providing membership for the student to a proprietary online student community with social or academic user-generated content and/or a notebook-specific code providing entry for the student to enter an online website for receipt of promotions or free samples.

According to another aspect of the present invention a school spiral notebook is provided which includes the front cover having on a front side thereof a texturized paper patch allowing ink or pencil writing thereon and/or a product sample removably attached to the front cover and a polybag wrap holding the sample to the notebook until removed by the student recipient or purchaser.

According to another aspect of the present invention a school spiral notebook is provided which includes a screen with a USB driver.

According to a further aspect of the present invention a school spiral notebook is provided which includes: a front cover; a back cover; a plurality of school custom-content sheets having custom content thereon specific to a school whose students are the intended recipients of the notebooks; at least one divider sheet; a plurality of sets of writing paper sheets; at least one of the covers, the school sheets, the divider sheets or another sheet having advertising content thereon; and a plastic spiral binder binding the covers, sheets and paper together in a notebook form.

Other objects and advantages of the present invention will become more apparent to those persons having ordinary skill in the art to which the present invention pertains from the foregoing description taken in conjunction with the accompanying drawings.

### BRIEF DESCRIPTION OF THE DRAWINGS

FIG. 1 is a front perspective view of a spiral notebook of the present invention in a closed position;

FIG. 2 is a perspective view of the notebook of FIG. 1 with a product sample attached thereto;

FIG. 3 is a perspective view of the notebook in a first open position;

FIG. 4 is a perspective view of the notebook in a second open position;

FIG. 5 is a perspective view of the notebook in a third open position;

FIG. 6 is a perspective view of the notebook in a fourth open position;

FIG. 7 is a perspective view of the notebook in a fifth open position;

FIG. 8 is a front perspective view of a spiral notebook which is a variation of the notebook of FIG. 1;

FIG. 9 is a rear perspective view of the notebook of FIG. 1;

FIG. 10 is a perspective view of the notebook in a sixth open position; and

FIGS. 11A and 11B illustrate a flow chart showing a notebook design and production method (or system) of the present invention.

### DETAILED DESCRIPTION OF PREFERRED EMBODIMENTS OF THE INVENTION

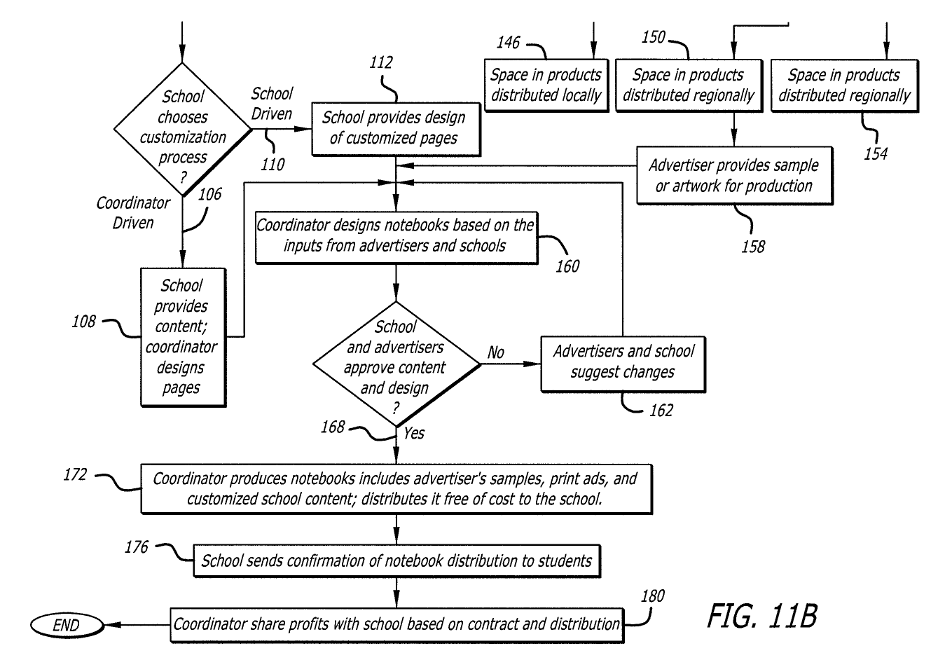

Pursuant to one aspect of the present invention, disclosed herein are a method or system for designing, producing and distributing customized spiral notebooks to intended student recipients of one or more schools. A flow chart illustrating this method/system is illustrated in FIGS. 11A and 11B generally at 50. Referring thereto, the production coordinator begins at block 54 and proceeds in two paths—one for the schools 58 and the other for the advertisers 62. These paths can run simultaneously, can run one before the other, or can alternate, with one path proceeding for a while, followed by the other path, back to the first path, and so forth, until the two paths meet as will be described later.

The school's path 58, on the left side of FIGS. 11A and 11B, will be discussed first. The coordinator picks a school 66 from a database of schools 70 (e.g., colleges, universities, private high schools, etc.), identifies and contacts the school representatives 74 to establish a partnership. If the school does not agree to the partnership 78 then the coordinator returns to the Start 54 and picks another school. If the school agrees to the partnership 82, then the school will choose from among alternative packages 86, three of which are illustrated in the drawing by reference numerals 90, 94, 98.

Each of the packages can include an option to sign a co-branding agreement. The second and third options 94, 98 include profit sharing agreements, with the second option 94 being a low profit sharing arrangement and the third option 98 being a high profit sharing arrangement. After the school has chosen the desired package and signed the agreement, then the school is added 100 to the coordinator's list of schools 102 having a partnership with the coordinator. The customization process can be either company-driven 106, meaning that the school provides the content and the coordinator designs the pages 108, or it can be school-driven 110, meaning that the school provides the design of the customized pages 112.

Returning to the beginning of the advertisers' path 64, the coordinator picks an advertiser 114 from a database of advertisers 118, contacts the advertiser 122 to offer advertising space on the notebooks to be produced and distributed to the partner schools, in which case the advertiser can agree to have its advertisements 126 and/or its products 130 added to the notebook. The advertiser is then added 134 to a list of partner advertisers 138. The advertiser then chooses the coverage level 142, an example of which can be geographical coverage level. Illustrated in FIG. 11B are alternative local 146, regional 150 and national 154 coverage levels. For the local level 146, the advertiser may target particular sets of schools or even individual schools, selecting as few as one individual partner school. For the regional coverage level 150 the advertiser targets partner schools in broad regions of the country, for example notebooks distributed to all partner schools in California. The national level choice 154 is for distributing the notebooks to all partner schools across the nation. The advertiser then provides samples or artwork for production 158 to the coordinator.

Referring to the block 160, the coordinator then takes the school-designed pages and the advertiser-designed pages and designs a notebook based on the input from the advertisers and the schools. The prototype design notebook is given to the schools and the advertisers who can suggest changes to the coordinator 162. Alternatively, only when the schools ask will a prototype be delivered and it can be an electronic version. The coordinator can then make any desired changes and resubmit the prototype design for approval. Once the school and advertiser produced content is approved 168, the coordinator assembles the notebooks, inserting the advertising pages, including any product samples, and the customized school content, then manufactures and distributes the completed custom spiral notebooks free of cost to the school 172.

The school sends confirmation 176 to the coordinator that the notebooks have been distributed to the students. The coordinator then shares their profits from the advertising with the school according to their contract and the level of distribution 180. The coordinator can then start the process over at block 54 with a new school and/or advertiser. Or the process can be repeated at a later semester, quarter or academic year with the same school.

The coordinator and the school can thus enter into a contract having three components—a notebook agreement, a profit sharing agreement and a co-branding agreement. The notebook agreement can be a one year, two year or three year exclusive agreement with the coordinator. The coordinator agrees to provide the notebooks, creates or assists in creating custom content, and delivers the final notebooks to the schools. The schools create the custom cover and the custom content, and receive and distribute the notebooks to the students. The schools also review and approve the advertisers prior to production. Although the schools agree to a minimum number of notebooks to distribute each semester, they can increase the number during the contract period.

Pursuant to the profit sharing agreement the schools, depending on the length of their exclusive agreement, receive a contribution from the coordinator which can range from nothing to twenty-five cents per notebook, for example. Under the co-branding agreement, the schools agree with the coordinator to co-brand the design, artwork, look and feel of the notebooks.

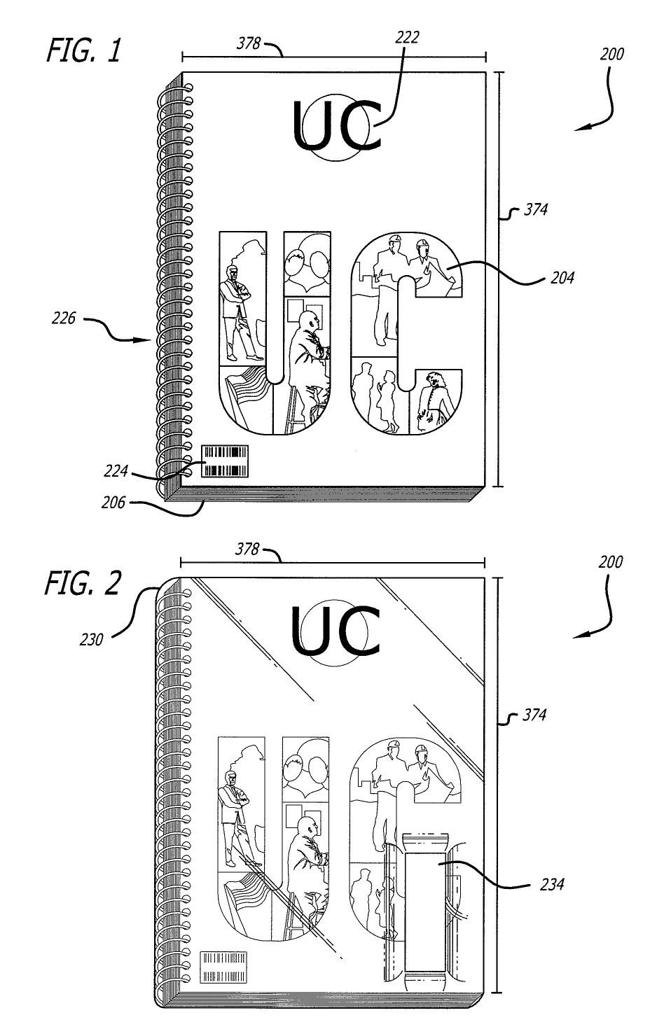

FIG. 1 shows a spiral notebook 200 of the present invention, including a front cover 204, a back cover 206, content sheets 210, divider sheets 214, and sets of writing paper 218 between the divider sheets. The front cover 204 can be a customized cover having the school's particular design 222 thereon, which can include the name, logo, mascot or other identifying information for the school. A bar code 224 can be included on the cover 204 allowing the coordinator to verify distribution of each of the notebooks to the students as well as for tracking of advertisements and other promotions. The spiral binder 226 can be a plastic or metal spiral binder, as decided by the school.

Optional packaging for the notebook is illustrated in FIG. 2, and can be polywrap packaging 230, where the notebook 200 is wrapped in a polyurethane bag to package product samples 234 and gifts from advertisers. The product samples 234, for example, can be generic product samples such as gum, pencils and coupons, and can comprise free-standing inserts.

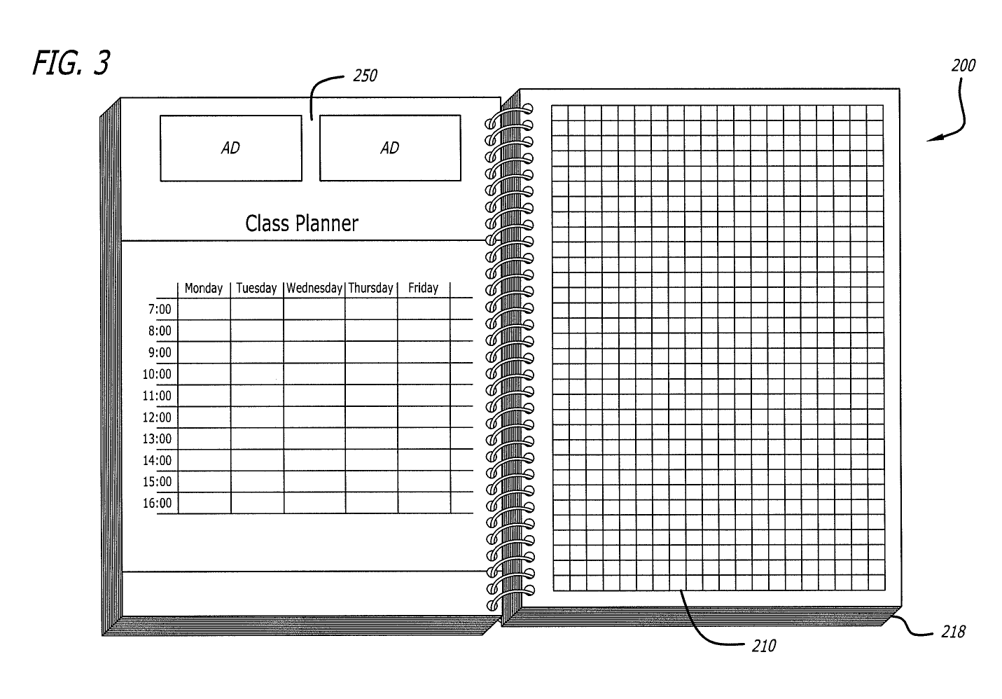

FIG. 3 shows examples of the custom content pages 210, which can include the custom content from the respective school. The content of the page 210 can also include a color or black-and-white map of the campus, which identifies the various campus buildings and roads. Another example of a school content page can be an academic calendar which shows the various class holidays, the first and last days of class quarters or semesters, the dates for mid-term and final examinations, and so forth. Other non-academic dates associated with the school (or the community) can also be noted in this calendar, such as sporting and recreational events.

A further content page can be a class planner 250 providing a matrix which allows the students to write the times, days and room numbers of each of their classes for each day of the week. This can be a generic type of layout requiring no input from the school.

Further examples of content pages can be welcome letters from the college administration or the college student government. School web site information can be provided. Another example is general charts of academic information, such as grammar rules, math formulas, metric conversion tables, maps and periodic tables. A separate sports calendar showing sporting events, times and days of sporting events for the school. In a separate calendar or on one of the previous mentioned calendars various community events can be noted. The writing paper or fill paper can be college ruled paper, graph paper, blank paper, or other paper, including logarithmic paper. Thirteen-pound bond paper can be used. Each set of writing paper between dividers can be all the same type of paper, ruled, graph or blank, or each can contain more than one type of paper. One of the sheets in the notebook can have a pocket 260 for holding a CD-ROM or other optical disc 264. Alternatively, a separate plastic sheet having pockets on both sides for holding two optical discs on each side can be included in the notebook 200 between the covers.

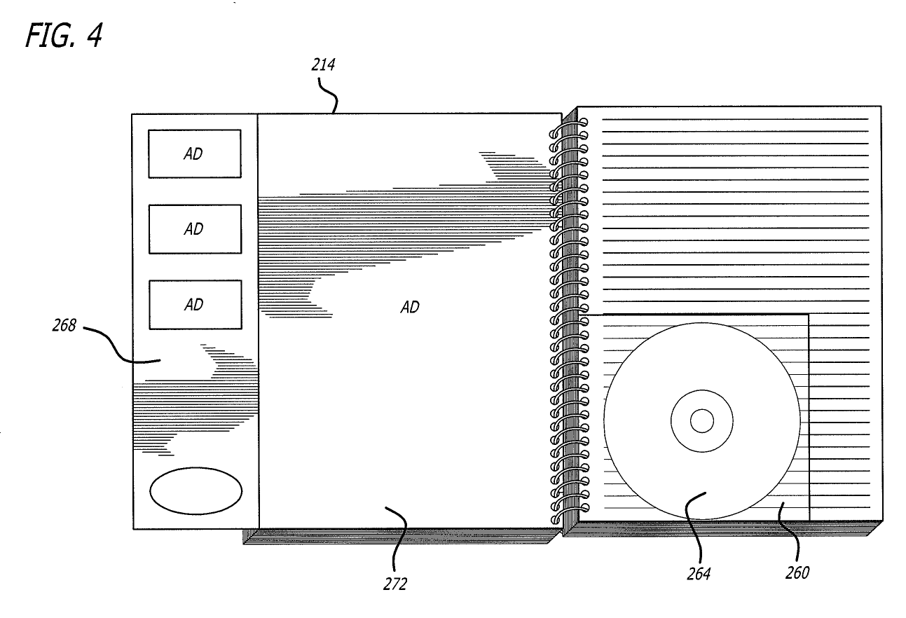

The dividers 214 can include full-page, four-color ads on glossy coated 10-point paper. As illustrated in FIG. 4, a gatefold sheet 268 can be included. It might include a full-page, four-color ad 272 on glossy coated 10-point paper folded inside the notebook, including advertising and/or product sampling.

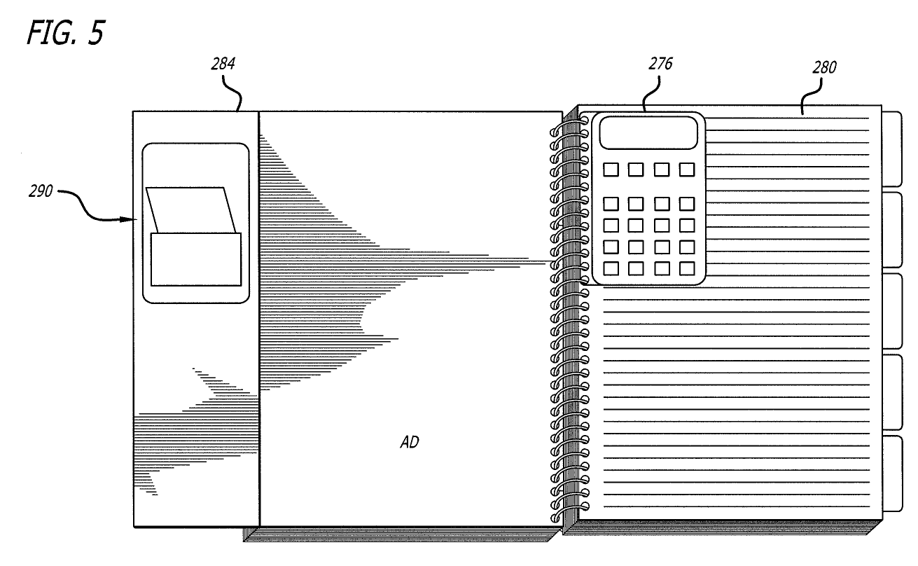

A paper-thin, solar-powered calculator 276 can be impregnated inside one of the custom content pages 280 as shown in FIG. 5. On the gatefold 284 or on the body of one of the divider sheets or custom sheets a POST-IT® note dispenser 290 can be attached. A vanity mirror can be mounted on one of the custom content pages or on one of the covers.

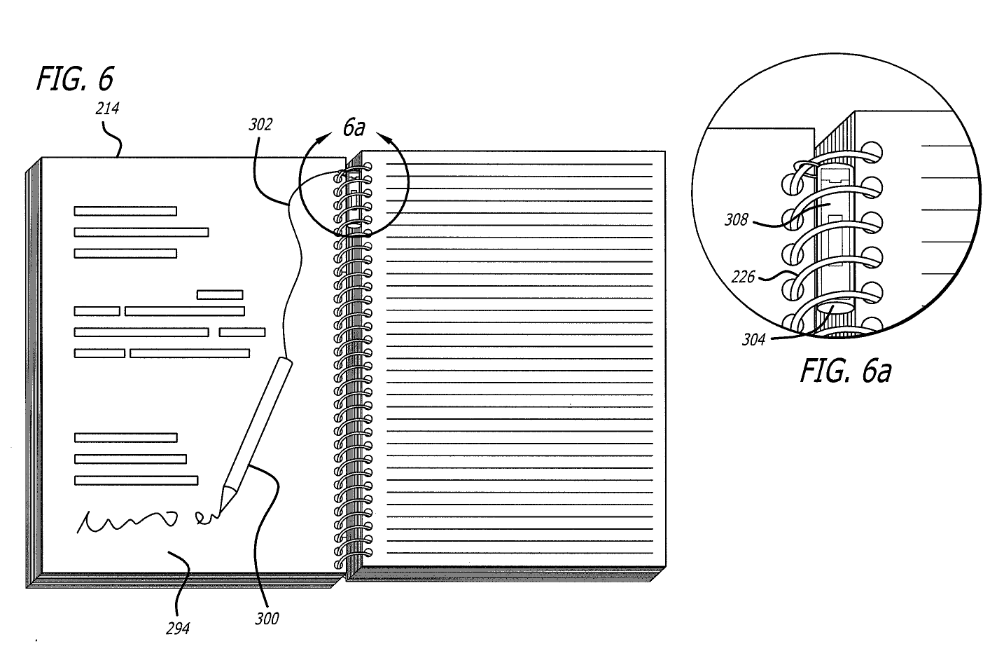

The spiral notebook can further include between the covers an erasable whiteboard 294, particularly a flexible sheet of special paper with whiteboard-type characteristics allowing erasable notes to be taken. This is illustrated in FIG. 6. Attached to the notebook, such as to the spiral binding, can be a dry erase pen 300 for the whiteboard and attached with a cord 302. Alternatively, the pen 300 can be positioned in a pocket of the notebook, such as pocket 382.

Further illustrated in FIG. 6 is a USB sleeve option of the present invention. As shown in greater in detail in FIG. 6A, it can be a plastic pouch 304 about four inches long positioned inside the spiral binding 226 for storage of various articles 308, such as a portable media player such as an IPOD NANO® media player, a USB key, or other contents. It can have a water-tight, closeable opening, and the pouch 304 can be moveably or fixedly attached within the spiral binder 226. Further, a USB flash drive, having storage, which is a storage device compatible with computers and electronic screens, can be included.

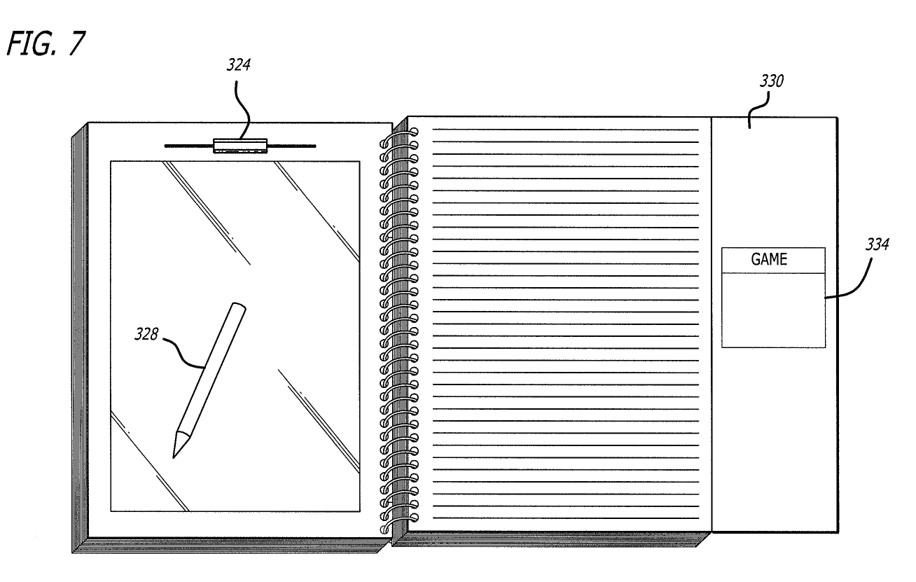

A writeable screen 320, namely an electronic screen capable of exporting content to a memory storage device, is illustrated in FIG. 7 as part of the notebook. A stylus holder 324 allows the stylus 328, which is used to write on the electronic screen 320, to be clipped into position in the notebook 200.

The gatefold page 330 on the right of FIG. 7 shows a contest or game 334 attached to the gatefold. It can include a notebook-specific code for the user to enter an online price contest, for example, at the end of each semester or quarter. A notebook-specific code can also be included for the user to obtain membership to proprietary online student community with social and academic user-generated content, such as students' pictures, teacher reviews and so forth. Further, a notebook-specific code can be included for the user to enter online web site (or part and parcel of the online community group described in the paragraph above) where the student receives promotions and free samples of selected products, such as consumer goods, games, coupons and so forth. The gatefold or other page can further include a horoscope for each month of a particular semester or quarter and hidden by a scratchable covering can be included in the notebook.

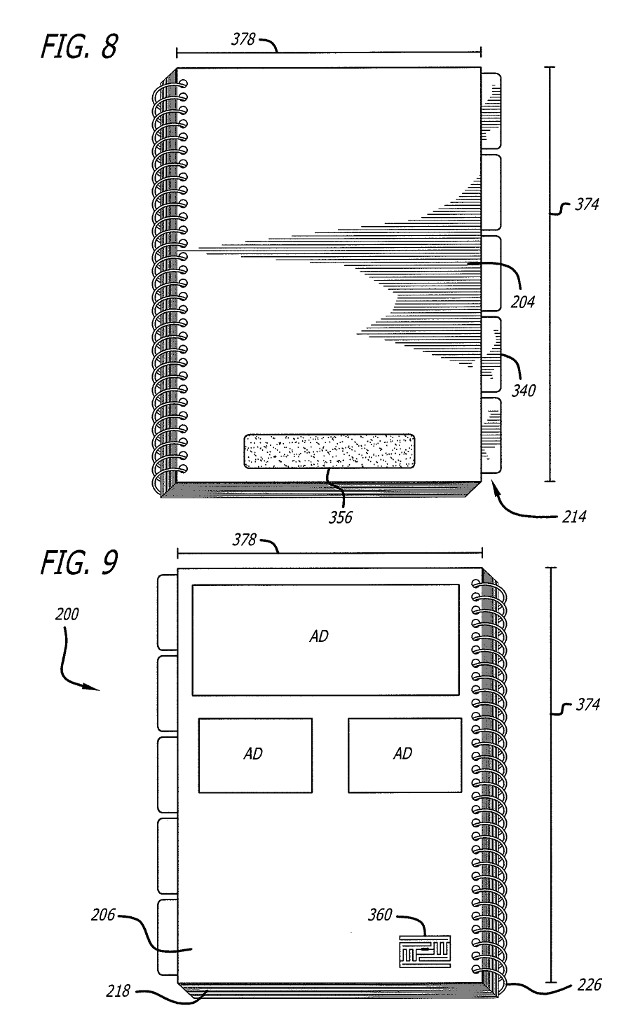

An alternative spiral notebook of the invention is illustrated in FIG. 8 wherein the dividers 214 are each tabbed dividers providing ready access to the set of writing paper following the tabbed dividers. The tabs 340 can also include surfaces on which the student can attach labels or write indicia indicating the class or subject matter associated with each of the respective notebook sections. Instead of having a tab divider, each of the dividers 214 can have a greater width than the width of the writing pages thereby allowing easy access by the user's fingers. FIG. 8 thereby illustrates that the tabs 340 can allow the users to more easily navigate the five or so different subjects. The tab function can thus be achieved, as mentioned above, by either slightly increasing the width of the divider page so that it protrudes farther than the writing paper or by including a distinct tab.

Further illustrated in FIG. 8 is a space on the front of the cover having a texturized paper patch 356 allowing ink or pencil to be used so that the recipient owner of the notebook can write his or her name or other identifying information.

FIG. 9 illustrates the incorporation of RFID technology 360 into the notebooks of the present invention. This allows the user to locate their notebooks. More particularly, it is an automatic identification that relies on storing and remotely retrieving data using devices called RFID tags or transponders. Passive tags which require no internal power source can be used. The lack of on-board power supply means that the RFID device can be very small. Commercially available products exist which can be used that are embedded in a sticker. The RFID can be used to track the shipment, distribution and use of the notebooks. The tracking can be shown to the advertisers to prove delivery and usage of the notebooks by the students. Additionally, the RFID tags can be used to provide a means for the students to locate their notebooks in case they are lost or stolen.

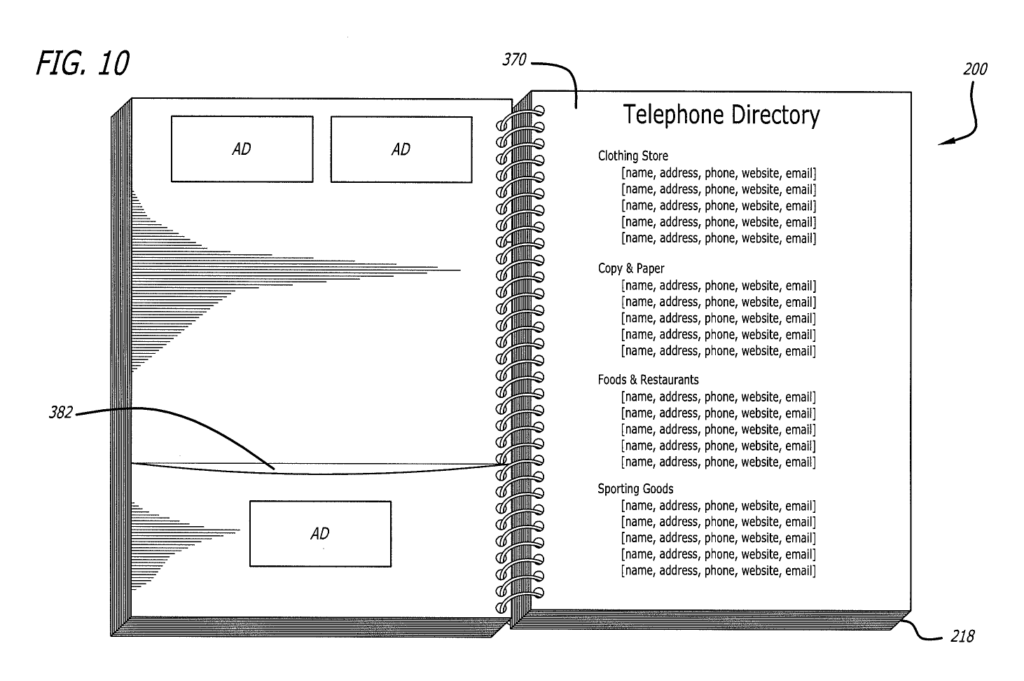

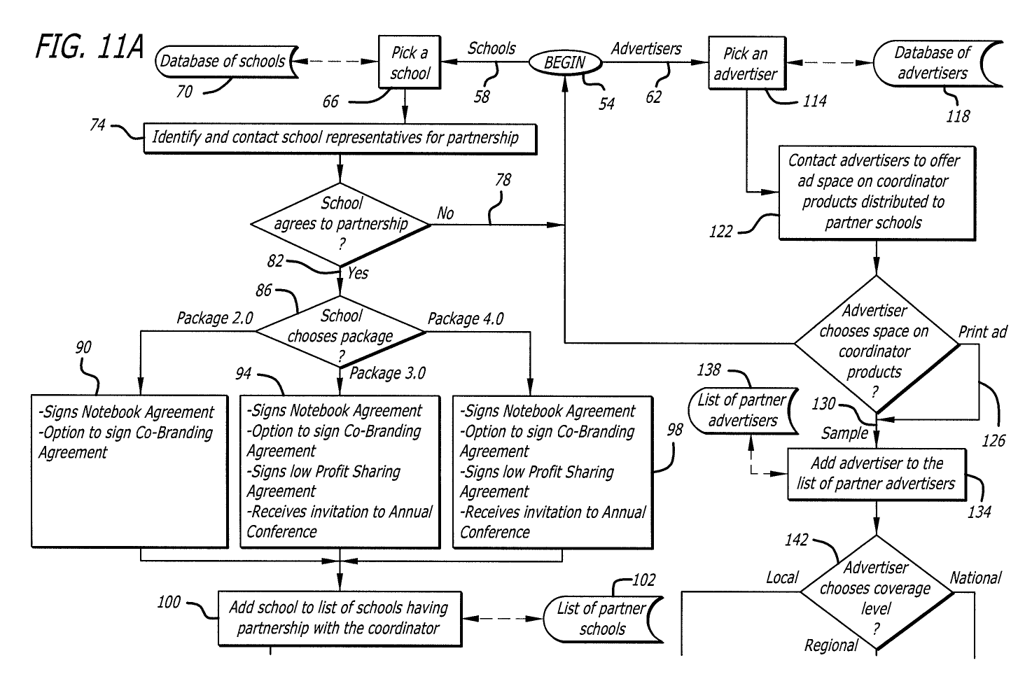

FIG. 10 shows the inclusion in the notebook of a telephone directory 370. This page can be located either next to the school custom content page or an advertisement page. For example, the directory might include telephone numbers for the various colleges or departments within the school (university), the various clubs, and the various student organizations, campus businesses, and local businesses. The trademarks and logos for these various businesses can be included in this directory.

The cover design can not only include the name and logo of the school, but it can also include artwork co-branded to the school, such as pictures, photo-realistic graphics, color schemes and so forth, which can be designed by the coordinator, the school or both. The cover 204 (and 206) can be made from glossy, high-print quality paper and can be two hundred and twenty pound or 18-point.

The content design sheets 210 and the dividers 214 can be made of coated, shiny, glassy paper, such as one hundred and forty-four pound, two hundred and twenty pound or 10-point paper. The dividers can be between one and ten dividers, or six to eight dividers, or five dividers per notebook can be provided. The writing paper 218 can be one hundred sheets minimum, two hundred sheets maximum, or approximately one hundred and sixty sheets total. There can be thirty-two sheets per section, for example.

The covers 204, 206 can be one millimeter thick and the (glossy) dividers and (glossy) content sheets 210 can be approximately 0.5 millimeter thick. The notebooks 200 can have length 374 and width 378 dimensions of 7.68×10.24 inches, or 8.5×11.0 inches, or 6.75×9.25 inches. A ruler marking along the vertical or horizontal edge of the notebook, particularly the covers thereof, can be provided allowing the user to user his notebook as a measuring ruler.

To assist with the design of the notebooks, the intended student recipients can complete an online pre-production survey. The information received can be used to specify customized categories of advertising, to get an idea of the tastes and desires of students of a particular school. Alternatively, it can be used to custom design the notebooks for each of the intended student recipients. Thus, the student customization from the student input might include more than simply desired advertising types from the student. For example, it might include a male/female designation to tailor the designs and color schemes used on the notebooks. It can include information which affects the non-advertising content such as the student's particular academic department, which can be used to include a list of faculty contact information and/or information on the department's activities for the school year, and/or information on different majors within that department. Further, student organizations in that department can be listed in the school content pages for that student's notebook. This customization can include clubs in which the particular student is interested. This allows contact information for that club to be included, and the club itself may want to buy advertising space in those notebooks. Fraternities and sororities might want to purchase space as well.

Another customization criteria can be the sports which the student is interested in so as to included relevant information such as the football team's schedule. Another customization item might be the student's residence so as to include information on the dormitory, apartment or section of town. The notebook then might include advertisements from businesses proximate to those residences such as nearby restaurants, banks or video arcades. A further item might be the student's favorite food types so as to include advertisements or coupons from those food establishments proximate to the school. The advertisers will likely pay more for such a very user-specific design approach for the notebooks. The customization information can be collected online or by other means.

If the student does not complete the survey, the default may be that he or she receives the basic notebook or gets the same notebook that he or she received the previous semester or quarter. A further alternative is to produce a number of specific variations or combinations of notebooks and then allow the students to pick which one they want either before production, which would allow for a greater control over the numbers of each category produced, or postproduction. In other words, there might be notebooks which are more sports-oriented or engineering major-oriented or community service-oriented, having school and advertising content and notebook design individually tailored for each category. Further, particularly for incoming freshman, this survey can be completed before they arrive on campus and the notebooks produced and sent to them before they arrive on campus or be waiting for them in their dorm rooms. The notebooks would help to familiarize the students with the school and the products and services available to them.

A further alternative is for the custom notebooks to have different designs, shapes, and/or color combinations allowing the students to not only more quickly identify their own notebooks, but also to allow students to identify the notebooks of other students. For example, brown notebook covers might be provided for engineering majors, red for science majors, vertical stripes for Republicans, horizontal stripes for Democrats, red plastic spirals for in-state students, blue plastic spirals for out-of-state students, dark covers for freshman, gray covers for other undergraduates, and white covers for graduate students, and so forth. This may help new students identify fellow students with similar interests or backgrounds and may provide talking points to help with the socialization process.

From the foregoing detailed description, it will be evident that there are a number of changes, adaptations and modifications of the present invention which come within the province of those skilled in the art. The scope of the invention includes any combination of the elements from the different species or embodiments disclosed herein, as well as subassemblies, assemblies, and methods thereof. However, it is intended that all such variations not departing from the spirit of the invention be considered as within the scope thereof.

What is claimed is:

1. A method for producing custom school spiral notebooks, comprising:
contacting a plurality of schools regarding forming school notebook production partnerships;
forming school notebook production partnerships with at least some of the plurality of schools and the at least some of the plurality of schools thereby becoming partnership schools;
one of the partnership schools defining a designated partnership school;
offering at least one school notebook advertising plan to a plurality of potential advertisers, at least some of which agree to the at least one school notebook advertising plan and thereby become advertisers;
receiving school information for customized notebook pages or dividers and/or covers from the designated partnership school;
receiving advertising information for customized notebook pages, customized dividers and/or customized covers from at least some of the advertisers;
designing custom notebooks using the school information and the advertising information;
receiving input on the designed custom notebooks from at least one of the advertisers and/or the designated partnership school;
after the receiving input, finalizing the custom spiral notebook design to produce a final notebook design;
producing custom spiral notebooks using the final notebook design;
distributing the custom spiral notebooks to the designated partnership school at no cost to the designated partnership school; and
sharing advertising profits with the designated partnership school.

2. The method of claim 1 wherein the at least one school notebook advertising plan includes different alternative plans.

3. The method of claim 2 wherein the different alternative plans include a national plan, a regional plan and a local plan.

4. The method of claim 1 wherein the custom spiral notebook includes a whiteboard flexible sheet on which erasable notes can be written by a dry erase pen by a recipient student.

5. The method of claim 1 wherein the school information includes school phone numbers, a school map, and a school calendar, and a front cover of the custom spiral notebook includes the name, logo, mascot, seal or other identifying indicia associated with the designated partnership school.

6. The method of claim 1 wherein the custom spiral notebook includes a class schedule page having a matrix of blank spaces in which a student recipient of the notebook can insert his or her class schedule information.

7. The method of claim 1 wherein the designated partnership school defines a first designated partnership school, the school information defines first school information, the advertising information defines first advertising information, the custom spiral notebook design defines a first custom spiral notebook design, and the final notebook design defines a first final notebook design; and further comprising:
another one of the partnership schools defining a second designated partnership school;
receiving second school information for customized notebook pages or dividers and/or covers from the second designated partnership school;
receiving second advertising information for customized notebook pages or dividers and/or covers from at least some of the advertisers;
designing second custom notebooks using the second school information and the second advertising information;
receiving input on the second designed custom notebooks from at least one of the advertisers and/or the second designated partnership school;
after the receiving input, finalizing the second custom spiral notebook design to produce a second final notebook design;
producing second custom spiral notebooks using the second final notebook design;
distributing the second custom spiral notebooks to the second designated partnership school at no cost to the second designated partnership school; and
sharing advertising profits with the second designated partnership school.

8. The method of claim 7 wherein at least some of the first advertising information is the same as at least some of the second advertising information.

9. The method of claim 1 wherein the custom spiral notebook includes a front cover, a back cover, first and second glossy sheets after the front cover, followed by a first set of writing pages, followed by a third glossy sheet, followed by a second set of writing pages, followed by a fourth glossy sheet, followed by a third set of writing pages, at least one of the first, second, third, and fourth glossy sheets including at least some of the school information, and at least one other of the first, second, third and fourth glossy sheets including at least some of the advertising information.

10. The method of claim 1 further comprising obtaining approval from the designated partnership school of the advertisers and/or the advertising information.

11. The method of claim 1 wherein the custom spiral notebook includes an attached RFID tag allowing a student recipient of the custom spiral notebook to track the location of the custom spiral notebook and/or an attached RFID tag providing proof of receipt and use of the custom spiral notebook to at least one of the advertisers.

12. The method of claim 1 wherein the custom spiral notebook includes tabbed divider sheets, at least some of which include the advertising information and/or the school information, and wherein the custom spiral notebook includes a back cover, a front cover, 6-8 dividers, and 140-180 sheets of writing paper.

13. The method of claim 1 wherein the custom spiral notebook includes a bar code allowing for verification of distribution of the custom spiral notebooks to students, and/or for tracking of advertisements and/or other promotions.

14. The method of claim 1 wherein the custom spiral notebook design includes input from intended student recipients thereof.

15. The method of claim 14 further comprising receiving the input from the intended student recipient via online.

16. The method of claim 1 further comprising receiving design and/or information input from each intended student recipient and the custom spiral notebook design for each intended student recipient including the design and/or information input.

17. The method of claim 1 wherein the custom spiral notebook includes a front cover, followed by pages including the advertisement information and/or the school information, followed by a plastic sheet with pockets able to hold two optical discs such as CD-ROMs on each side, followed by the first class/subject divider, followed by writing pages and a back cover.

18. The method of claim 1 wherein the custom spiral notebook includes a spiral binder and a pouch in the spiral binder for storage of one or more small articles.

19. The method of claim 1 wherein the advertising information includes advertising samples or artwork.

20. The method of claim 1 further comprising receiving confirmation from the designated partnership school that the custom spiral notebooks were distributed to students of the designated partnership school.

21. The method of claim 1 wherein the school notebook production partnerships are co-branding partnerships.

22. The method of claim 1 wherein the custom spiral notebook includes a custom content page and a thin solar-powered calculator impregnated inside the custom content page, and/or a horoscope for each month of a semester or quarter of the designated partnership school and hidden by a scratchable covering.

23. The method of claim 1 wherein the custom spiral notebook includes a notebook-specific code for the recipient student to enter an online prize contest and/or a notebook-specific code providing membership for the recipient student to a proprietary online student community with social and/or academic user-generated content and/or a notebook-specific code providing entry for a recipient student to enter an online website for receipt of promotions and/or free samples.

24. The method of claim 1 wherein the school information includes a directory of phone numbers for the designated partnership school, a directory of phone numbers for businesses near the designated partnership school, a map of the campus of the designated partnership school, and a calendar of events associated with the designated partnership school, and wherein the custom spiral notebook includes a class planner page having locations for the student recipient to write the times, days and locations of his or her classes.

25. A custom school spiral notebook, comprising:
a front cover;
a back cover;
a plurality of school custom-content sheets having custom content thereon specific to a school whose students are notebook intended recipients;
at least one divider sheet;
a plurality of sets of writing paper sheets;
at least one of the covers, the school sheets, the divider sheets or another sheet having advertising content thereon; and
a spiral binder binding the covers, sheets and paper together in a notebook form.

26. The custom school spiral notebook of claim 25 wherein the custom content includes school phone numbers, a school map, and a school calendar, and wherein the front cover includes at least one of the name, logo, mascot, seal or other identifying indicia of the school.

27. The custom school spiral notebook of claim 25 wherein the custom content includes a class schedule sheet having a matrix of blank spaces in which a student recipient of the notebook can insert his or her class schedule.

28. The custom school spiral notebook of claim 25 wherein the school sheets and the divider sheets are glossy coated sheets.

29. The custom school spiral notebook of claim 25 wherein at least one of the covers, school sheets or divider sheets includes a pocket.

30. The custom school spiral notebook of claim 25 wherein the custom content includes business directory information for businesses local to the school.

31. The custom school spiral notebook of claim 25 further comprising an attached RFID tag allowing a student recipient of the custom school spiral notebook to track the location of the custom school spiral notebook and/or an attached RFID tag providing proof of receipt and use of the custom school spiral notebook to at least one of the advertisers of the advertising content.

32. The custom school spiral notebook of claim 25 wherein the divider sheets are tabbed divider sheets, at least one of which includes custom content specific to the school.

33. The custom school spiral notebook of claim 25 wherein the spiral binder is a plastic spiral binder.

34. The custom school spiral notebook of claim 25 wherein the plurality of divided sheets includes 6-8 divider sheets, and the writing paper includes 140-180 sheets of paper, and/or wherein the custom school spiral notebook has dimensions of generally 7.68×10.24 inches, 8.5×11.0 inches or 6.75×9.25 inches.

35. The custom school spiral notebook of claim 25 further comprising a bar code allowing for verification of distribution of the notebook to a student, and/or for tracking of advertisements and/or other promotions.

36. The custom school spiral notebook of claim 25 further comprising one of the divider sheets having an optical disc pocket and/or a plastic sheet with pockets able to hold two optical discs such as CD-ROMs on each side thereof.

37. The custom school spiral notebook of claim 25 further comprising a pouch in the spiral binder for storage of one or more small articles.

38. The custom school spiral notebook of claim 37 wherein the pouch is about four inches long, is made of plastic, has a water-sealable opening and is positioned at a top end of the spiral binder.

39. The custom school spiral notebook of claim 25 further comprising a perforated tear-off gatefold sheet between the covers.

40. The custom school spiral notebook of claim 25 further comprising a thin solar-powered calculator impregnated inside a sheet of the custom school spiral notebook.

41. The custom school spiral notebook of claim 25 wherein the custom content includes a horoscope for each month of a semester or quarter of the school and hidden by a scratchable covering.

42. The custom school spiral notebook of claim 25 further comprising a notebook-specific code for a recipient student to enter an online prize contest and/or a notebook-specific code providing membership for a recipient student to a proprietary online student community with social and academic user-generated content and/or a notebook-specific code providing entry for a recipient student to enter an online website for receipt of promotions and/or free samples.

43. The custom school spiral notebook of claim 25 wherein the custom content includes a directory of phone numbers of the school, a directory of phone numbers for businesses near the school, a map of the campus of the school, and a calendar of events associated with the school, and further comprising a class planner page having locations for a student recipient to write the times, days and locations of his or her school classes.

44. The custom school spiral notebook of claim 25 wherein the custom content includes one or more of a welcome letter from an official of the school, a table of academic information indicia, and a calendar of sporting events for the school, and wherein the table of academic information indicia includes at least one of grammar rules, a metric conversion table, math formulas, a map and a periodic table of the elements.

45. The custom school spiral notebook of claim 25 further comprising a whiteboard flexible sheet between the covers on which erasable notes can be written by a dry-erase pen.

46. The custom school spiral notebook of claim 25 wherein the covers are 220 pound or 18-point and the dividers and the custom content sheets are 144 pound or 10-point, and wherein the at least one divider sheet includes between one and ten divider sheets and the writing paper sheets include between 100 and 200 sheets.

47. The custom school spiral notebook of claim 25 further comprising the front cover including on a front side thereof a texturized paper patch allowing ink or pencil writing thereon and/or a product sample removably attached to the front cover.

48. The custom school spiral notebook of claim 25 further comprising a container of individually removable adhesive notes attached to a sheet or a cover of the custom school spiral notebook.
